(19) United States
(12) Patent Application Publication
(10) Pub. No.: US 2008/0122242 A1
(43) Pub. Date: May 29, 2008

(54) Foldable vehicle seat

(75) Inventors: Burckhard Becker, Solingen (DE); Dirk Overbeck, Kerpen (DE)

Correspondence Address: MCCARTER & ENGLISH LLP;CITYPLACE I, 185 ASYLUM STREET, HARTFORD, CT, 06103, US

(73) Assignee: C. Rob. Hammerstein GmbH & Co. KG

(21) Appl. No.: 11/509,407

(22) Filed: Aug. 24, 2006

(30) Foreign Application Priority Data
Aug. 24, 2006 (DE) 10 2005 040 271.2

(51) Int. Cl. B60N 2/02

(52) U.S. Cl. 296/65.05

(57) ABSTRACT

The invention relates to a foldable vehicle seat comprising a base structure, a cushion support member, front support arms, which are each hinged to the cushion support member on the one side and at a front hinge to the base structure on the other side, a carrier member, which is hinged at an upper hinge point to the base structure and at a lower hinge point to the cushion support member, and with a seat back, which is pivotally hinged to the base structure, more specifically, to the upper hinge point. The carrier member comprises a control region having a front flank and a rear flank. A projection is formed on the seat back that extends into the control region, while fitting against the front flank in the normal position and coming to bear against the rear flank when the seat back is tilted forward a first angle; further, the projection pivots together with the carrier member when the seat back is tilted farther forward.

### CROSS REFERENCE TO RELATED APPLICATIONS

This application claims priority to German Application No. DE102005040271.2, filed Aug. 24, 2005, the contents of which are expressly incorporated by reference in their entirety as part of the present disclosure.

### BACKGROUND

The invention relates to a foldable vehicle seat with a base structure, with a cushion support member, with front support arms, which are each hinged to the cushion support member on the one side and at a front hinge to the base structure on the other side, and with a carrier member, which is hinged to the base structure and to the cushion support member, and with a seat back, which is pivotally hinged to the base structure.

Together with the base structure, the front support arms, the cushion support member and the carrier member form a four-bar linkage. The four-bar linkage can be adjusted so that the vehicle seat has a normal position of utilization on the one side and a folded position on the other side. In the folded position, the seat back is folded forward and is almost in the x direction, with the cushion support member and the seat cushion it carries being moved downward and additionally slightly backward. As a result, the seat back may take the place occupied by the cushion support member and the seat cushion in the normal position of utilization.

Such type foldable vehicle seats are suited in particular for the second or the third row in a motor vehicle. They are also referred to as foldaway vehicle seats. If the back side of the seat back is configured accordingly, it may be part of the cargo loading floor of the motor vehicle.

It is the object of the invention to indicate a foldable vehicle seat which has simple kinematics, is simple to operate and easy to realize in terms of construction and which also can be available both in a manually and in a motor-adjustable design, with the actual kinematics of the vehicle seat being manual or motor-driven, independent of the design.

### SUMMARY

This object is solved by a foldable vehicle seat with a base structure, with a cushion support member, with front support arms, which are each hinged to the cushion support member on the one side and at a front hinge to the base structure on the other side, and with a carrier member, which is hinged at an upper hinge point to the base structure and at a lower hinge point to the cushion support member, and with a seat back, which is pivotally hinged to the base structure, more specifically to the upper hinge point, the carrier member comprising a control region having a front flank and a rear flank and a projection being formed on the seat back, the projection extending into the control region, fitting against the front flank in the normal position and being configured on the seat back and coming to bear against the rear flank when the seat back is tilted forward a first angle and pivoting together with the carrier member when the seat back is tilted farther forward.

On this vehicle seat, the cushion support member is connected via front arms to the base structure in the usual way as described, for example, in European Patent No. EP0445528B, entitled “Vehicle Seat with a Seat Support, to which a Backrest is Fixed, and with a Seat Cushion,” which is hereby expressly incorporated by reference in its entirety as part of the present disclosure. In the rear region, the cushion support member is connected to the base structure via the carrier member, one carrier member being preferably provided for each seat side. Only one of these carrier members must comprise the control region with the two flanks, the projection being associated with this carrier member. It is preferred that both seat sides have carrier members configured in this way.

The seat back cooperates with the two flanks of the carrier member in such a manner that, in a first angular range, the unlocked seat back can be tilted forward freely from the normal position of utilization provided it is unlocked and that, in an angular range adjoining the first angular region, the seat back pivots together with the carrier members, in other words carries them along. The displacement of the cushion support member backward and in particular downward is controlled through the carrier members. In order to achieve noticeable displacement of the cushion support member downward, in the negative z direction, the carrier member is disposed in the normal position of utilization so as to ascend at an angle of e.g., about 15° from the lower hinge point toward the upper hinge point when viewed in the negative x direction. This clearly contrasts with the normal parallelogram kinematics as it is known for vehicle seats as described, see for example, the parallelogram arms 11 and 13 in EP0445528B or in FR2433433A. Vehicle seats with parallelogram kinematics have front support arms that are implemented to be similar and preferably almost identical to the object of the application, except for the fact that they have rear support arms rather than the carrier member, the rear support arms being oriented approximately parallel to the front support arms and being thus inclined at a completely different angle as compared to the carrier member, with the angle difference being in excess of about 90°, e.g., about 105°. As a result, the carrier member of the vehicle seat according to the application in its normal position of utilization substantially is an extended portion of the cushion support member and is not oriented transversely thereto. The upper hinge point is always located above the lower hinge point, irrespective of the respective kinematic state. With the normal parallelogram kinematic, it is exactly the reverse.

The vehicle seat of the invention makes it possible to beneficially couple the folding away of the cushion support member and the forward folding of the seat back. By actuating and folding the seat back forward, the movement of the cushion support member kinematically connected to the seat back is achieved. The kinematic connection is established via the control region, namely through the projection of the seat back abutting the rear flank. Once this abutment has been achieved, the seat back moves together with the support member as it is folded farther forward.

Starting from the normal position of utilization, the motor vehicle seat is folded forward and away in the following way: in the normal position of utilization, the projection of the seat back fits against the front flank. It is locked in this position. The four-bar linkage described is also locked as a result thereof. If the lock is released by a corresponding device, the seat back may be folded forward. At the same time, the four-bar linkage is no longer immobilized and may be moved. Now, the seat back may be folded forward a first angular range, with the limit stop coming free from the front flank and abutting the rear flank when the end of the first angular range has been reached. From this state onward, pivoting the seat back further forward by a corresponding pivotal movement is coupled to at least one carrier member. The carrier member pulls the seat carrier backward in the x direction and, more specifically, the movement of the carrier member lowers, together with the pivotal movement of the front support arms, the cushion member downward. The seat back can be brought into a horizontal position in which it is substantially oriented in the x direction.

Once the four-bar linkage has been released from immobilization and as soon as the seat back has been slightly folded forward, meaning as soon as the projection has left the front flank, the four-bar linkage is capable of folding by itself if it is configured to be sufficiently smooth running. It may however also be configured such that the configuration of the four-bar linkage is maintained until the projection abuts the rear flank and modifies the four-bar linkage only then.

This foldable vehicle seat has the particular advantage that the kinematics described hereto before is suited for adjustment both by hand and by an electric motor. For an adjustment by an electric motor, the projection, in a preferred developed implementation, is connected, preferably on one seat side only, to a connecting rod that is hinge-linked to a rocker arm of the motor, the rocker arm of the motor being in turn connected for rotation to an electric motor. The movement of the projection and, as a result thereof, of the seat back or the four-bar linkage is controlled through this arrangement. In the normal position of utilization, the connecting rod and the rocker arm of the motor are preferably arranged so as to be extended. As a result, loads such as occur when the motor vehicle seat is being used are prevented from having a direct effect on a transmission of the electric motor. The arrangement described immediately performs the immobilizing and also the release function.

In a manual implementation, there is provided a separate stop device that cooperates with both the front and the rear flank. In the normal position of utilization, it keeps the projection fitting against the front flank. In the folded position, it keeps the projection fitting against the rear flank. It is preferred that such a stop device be associated with only one seat side, but it may also be provided on both.

The base structure can have different configurations. It may for example be part of an underbody of a vehicle. This means that the foldable vehicle seat cannot be completely preassembled as a construction unit; when being mounted into a motor vehicle, the front support arms must be linked to a base structure and, in the same way the links between the at least one carrier member to the base structure and between the seat back and the base structure have to be established. Base structures are preferred that are part of the vehicle seat itself and that are in turn connected to an understructure of the motor vehicle during mounting of the vehicle seat into the vehicle. For this purpose, there are proposed either longitudinal adjusting devices allowing at the same time for forward and backward adjustment of the seat or simple base members, which may for example be simple profile members, with one profile member being provided for each seat side.

In another advantageous configuration, the lower hinge point is in proximity to a connecting line joining the front support arm joint and the upper hinge point. It is preferably located beneath the connecting line. As a result, the position of the carrier member in the normal position of utilization is characterized.

### BRIEF DESCRIPTION OF THE DRAWING

Further advantages and characteristics of the invention will become apparent from the other claims and from the following description of five embodiments of the invention, given by way of example only with reference to the drawing. In the drawing:

FIG. 1 is a perspective assembly drawing of a first exemplary embodiment of the foldable seat for the normal position of utilization;

FIG. 2 shows part of the component parts shown in the left part of FIG. 1 in a perspective view slightly different from that in FIG. 1;

FIG. 3 is a perspective representation like FIG. 1, but now for a second exemplary embodiment that is adjustable by hand;

FIG. 4 is a schematic side view of the third exemplary embodiment, which is motor-adjustable, for showing more clearly the procedure sequence;

FIG. 5 is a representation like FIG. 4, but now for a fourth exemplary embodiment that is adjustable by hand; and

FIG. 6 is a side view of a fifth exemplary embodiment, which is similar to the fourth exemplary embodiment, with the seat being now in the completely folded position.

### DETAILED DESCRIPTION

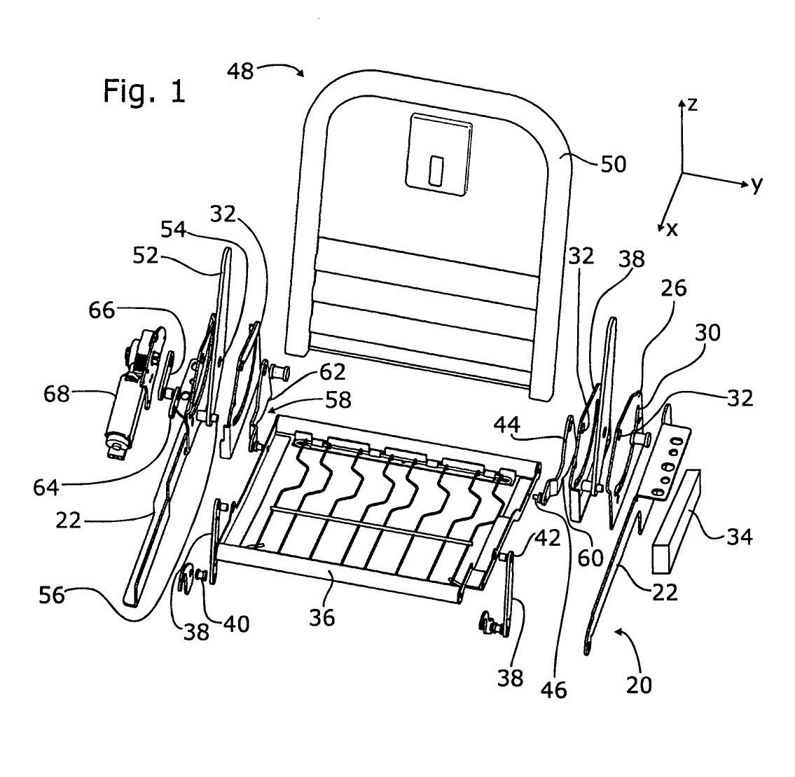

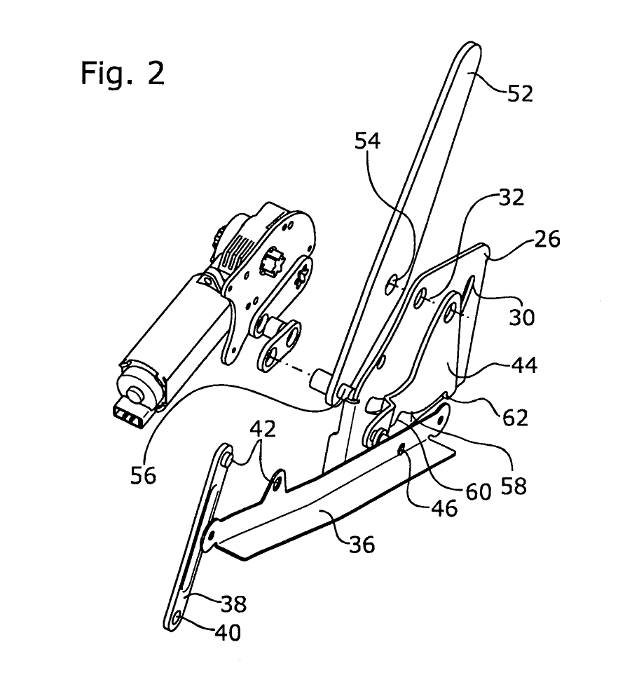

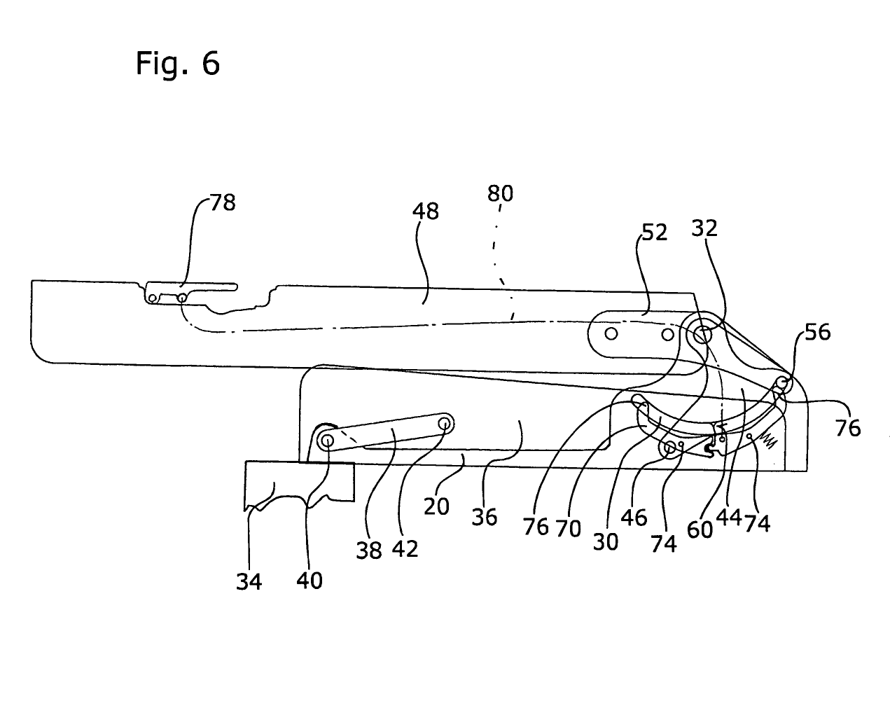

The foldable vehicle seat has a base structure, which, in the first exemplary embodiment according to the FIGS. 1 and 2, is formed from a left profile member 22 and a right profile member 24 as well as from guide members 26, 28 connected to these. The guide members 26, 28 are provided in respective pairs on either side and have a guide slot 30 and a hole, which forms an upper hinge point 32. Longitudinal adjusting devices known per se and having each a seat rail and a floor rail, may be provided instead of the two profile members 22, 24. However, in another alternative, the profile members 22, 24 may be solidly connected to an underbody 34 of a motor vehicle that has only been outlined in FIG. 1, or be formed from such an underbody 34. The profile members 22, 24 may each be connected with at least one guide member, see FIG. 6.

The foldable vehicle seat further has a cushion support member 36 of a known construction. It has a frame and springs disposed therein. It is intended to receive a seat cushion, which is not illustrated herein for being state of the art.

Front support arms 38 are further provided, they are built identically or rather in a mirror-inverted fashion. They are hinged to the base structure 20, concretely, to a respective one of the profile members 22 and 24, at a lower hinge 40. They are further hinged to the cushion support member 36 at an upper hinge 42. It can be seen that the upper hinges 42 are spaced a distance of about 10% to about 30% of the depth (in the x direction) of the cushion support member 36 apart from the front edge thereof.

There are further provided a left and a right carrier member 44, which are also built identically and arranged in a mirror inverted fashion. Each carrier member 44 is hinge-linked to the base structure 20 at the upper hinge point 32. The two upper hinge points 32 of each seat side are disposed on a straight line. At a lower hinge point 46, the carrier member 44 is hinge-linked to the cushion support member 36, which is approximately positioned at a distance corresponding to that of the upper hinges, 42 when seen from the rear edge of the cushion member 36.

On either seat side, the base structure 20 forms, together with the front support arms 38, the cushion support member 36 and the two carrier members 44, a four-bar linkage. The four-bar linkage may also be described by the upper hinge point 32, the lower hinge 40, the upper hinge 42 and the lower hinge point 46. The hinges described are free; the immobilization of the four-bar linkage will be explained herein after.

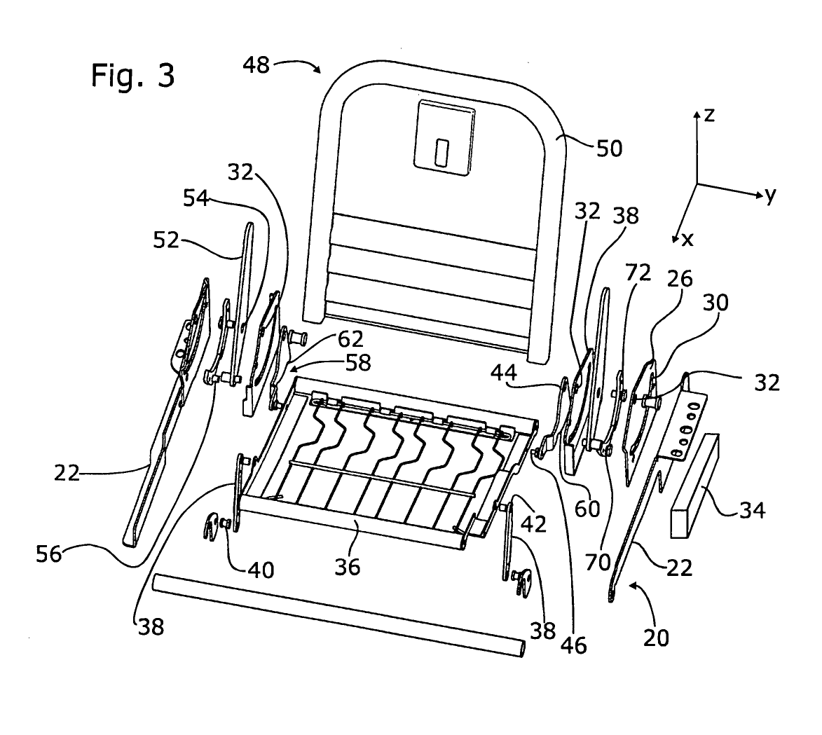

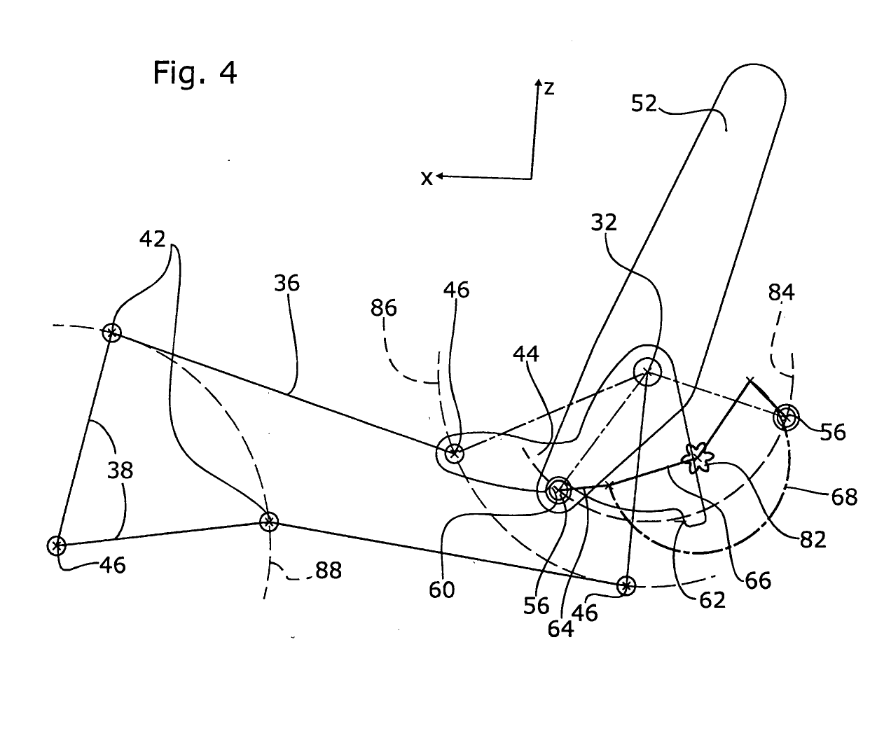

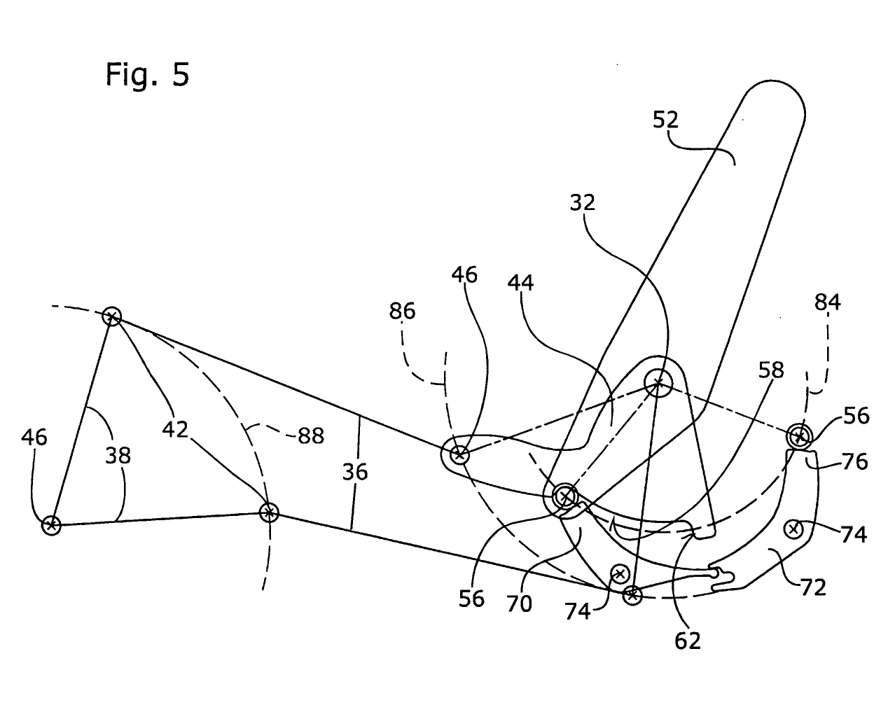

Finally, there is provided a seat back 48; it has a main part 50 and two seat back arms 52 disposed thereon. One seat back arm 52 is provided on either seat side. The seat back 48 is hinge-linked to the upper hinge point 32 through the seat back arms 52. A corresponding aperture 54 is provided for this purpose in the seat back arm 52. The hinge itself is realized by rivets or pins that can be seen in the FIG. On its seat back arms 52, the seat back 48 also has on either side one projection 56 or a bolt that is guided in the two guide slots 30 of the guide members 26, 28. Thus, the maximum pivot angle of the seat back 48 is imposed. The projection 56 cooperates with a control region 58 that is formed on each carrier member 44; however, it is sufficient to provide it on only one seat side, meaning on only one carrier member 44. This control region 58 is defined by a front flank 60 and by a rear flank 62. The projection is capable of coming into contact with both flanks. In the normal position of utilization as it is illustrated in the first exemplary embodiment, the projection 56 fits against the front flank 60 and is retained by an immobilization device the function of which is performed by a motor drive in the first exemplary embodiment. The motor drive has a connecting rod 64 that is rigidly connected to a respective one of the projections 56. The connecting rod 64 is hinge-linked to a rocker arm 66 of the motor, which in turn is non-rotatably linked to an electric motor 68. The electric motor is fixed on the base structure. In the normal position of utilization as it is shown in FIG. 1 and FIG. 2 as well as in FIG. 4, the rocker arm 66 of the motor and the connecting rod 64 are in an extended position. A load exerted onto the seat back 48, which causes the projection 56 to exert a pressure onto the connecting rod 64, therefore exerts a direct load onto the drive shaft of the motor, without a torque occurring. The FIGS. 3 and 5 also show the seat in the normal position of utilization, but for the manual implementation.

If the electric motor is actuated, it causes the projection 56 to move away from the front flank 60 and toward the rear flank 62. If the projection 56 reaches the rear flank 62, the vehicle seat is folded. Then, it has a structure similar to that shown in FIG. 6.

In the second exemplary embodiment shown in FIG. 3, the same parts can be found as in the first exemplary embodiment, again with the following exceptions that will be discussed as follows: Now, a manual stop device is provided instead of the motor drive. On each seat side, it has a front cam 70 and a rear cam 72. The cams 70, 72 are hinge-linked together by a kind of tooth or hinge engagement in their regions turned toward each other and they move like two meshing toothed wheels. The cams respectively have points of rotation 74. In their end regions pointed away from each other the cams have stop members 76. With one stop flank, they fit against the projection 56 in the respective stopped state. This cannot be seen in FIG. 3, but in FIG. 6, the reader being referred to the stop state, which is effected there by the rear cam 72, namely by the stop member 76 and its associated stop flank. The projection 56 is fixed between this rear cam 72 and the rear flank 62. The stop flank has a corresponding chamfer for a zero clearance fixation. An illustrated spring biases the arrangement of the two cams 70, 72, which can be moved together, into the stop position shown in the FIGS. 3 and 6. It can come free from the stop position by a release mechanism. It can be seen in FIG. 6. For this purpose, a release lever 78, which is connected to one of the two cams via a Bowden cable 80, is disposed on the seat back. By actuating the release lever 78, the two cams 70, 72 are pivoted to come free from their stop position so that the motor vehicle seat can be adjusted.

The fundamental functions will now be discussed with reference to the two FIGS. 4 and 5: In the implementations shown in the FIGS. 4 and 5, the motor vehicle seat, which has only been illustrated very schematically, is shown in the normal position of utilization. The sequence of movements may also be seen. The two FIGS. show that in the normal position of utilization the front support arms are slightly inclined backward, approximately 20 to 30 degrees as compared to the z direction; the support arms 38 are oriented approximately parallel to the seat back of which only one respective seat back arm 52 is shown. The distance between the two hinges 40, 42 of the support arms 38 approximately corresponds to the distance between the hinge points 32, 46 of the carrier member 44. The carrier member 44 is inclined at an angle of about 50° to the support arm 38. The hinge points of the already mentioned four-bar linkage are located so that the lower hinge 40 of the front support arm 38, the lower hinge point 46 and the upper hinge point 32 approximately lie on a straight line. Put more precisely, the lower hinge point 46 is located slightly beneath a connecting line joining the lower hinge 40 and the upper hinge point 32. The front support arm 38 and the cushion support member 36 are approximately disposed at a right angle with respect to one another in the region of the upper hinge 42.

The carrier member 44 is substantially L-shaped, with the upper hinge point 32 lying on the bar and the lower hinge point 46 on the transverse line. The upper hinge point 32 and the two flanks 60, 62 lie on the apexes of an isosceles, almost equilateral, triangle.

Upon actuation of the electric motor 68, which can be recognized by its pinion in FIG. 5, the hinge of the rocker arm 66 of the motor and of the electric motor 68 moves on the dash-dotted curved line 82 and performs a movement of slightly more than 180° about the motor shaft. Once this movement has been completed, the rocker arm 66 of the motor and the connecting rod 64 are no longer in an extended state, they rather substantially overlap. Then, the projection 56 abuts the rear flank 62. The projection 56 has traveled on a path 84 that lies on a circular arc about the upper hinge point 32 and is shown by a discontinuous line. The end position is pivoted about 110° with respect to the initial position. Approximately 50° thereof account for the distance between the two flanks 60, 62. The last mentioned region is the first angular region. According to the remaining difference of about 60°, the carrier member 44 is pivoted about the upper hinge point 32, this occurring along a curve 86 about the upper hinge point 32. It can be seen that the lower hinge point 46 now lies approximately beneath the upper hinge point 32 in the z direction. The lower hinge point 46 has been displaced a distance that approximately corresponds to the hinge distance of the support arm 38. Due to the end position described, the cushion support member 36 is substantially displaced in the negative x direction and slightly in the z direction. The definitive position in the completely folded state can be seen from FIG. 4. The upper hinge 42 thereby lies behind the lower hinge 40, when substantially viewed in the negative x direction. In the completely folded state, the lower hinge 40, the upper hinge 42 and the lower hinge point 46 are almost lying on a straight line. The upper hinge 42 pivots along a bottom line 88 about the lower hinge 40, with the pivot angle being about 70°.

The circumstances described herein above for FIG. 4 can also be seen in FIG. 5. FIG. 5 will now be substantially described with respect to the stop device. The two cams 70, 72 are hinge-linked to the base structure 20 and pivotal about the points of rotation 74. They may for example be disposed on a guide member 26, 28. In the normal position of utilization as shown in FIG. 5, one stop flank of the front cam 70 fits against the projection 56 and urges it against the front flank 60. The seat back is immobilized as a result thereof. At the same time, the four-bar linkage described is also immobilized. If the immobilization is released by actuating the release lever 78 as described, the other immobilization position, which has already been described herein above with respect to FIG. 6, is reached. In principle, this stop position can also be seen in FIG. 5.

FIG. 6 has already been mentioned. The release lever 78 is located on the rear side of the seat back 48 so that it is accessible at any time. It can be seen that the seat back is substantially horizontal. It can be brought flush with a cargo loading floor that has not been illustrated herein.

As may be recognized by those skilled in the pertinent art based on the teachings herein, numerous changes and modifications may be made to the above-described foldable vehicle seat without departing from the spirit and scope of the invention as defined in the appended claims. Accordingly, this detailed description is to be taken in an illustrative, as opposed to a limiting sense.

What is claimed is:

1. A foldable vehicle seat comprising:
a base structure;
a cushion support member;
front support arms having two sides and which are each hinged to the cushion support member on one of the two sides and at a front hinge to the base structure on the other of the two sides;
a seat back, which is pivotally hinged to the base structure;
a carrier member, which is hinged at an upper hinge point to the base structure and at a lower hinge point to the cushion support member, the carrier member comprising a control region having a front flank and a rear flank; and
a projection formed on the seat back, the projection extending into the control region and fitting against the front flank in the normal position and coming to bear against the rear flank when the seat back is tilted forward a first angle, further, the projection pivots together with the carrier member when the seat back is tilted farther forward.

2. The foldable vehicle seat as set forth in claim 1, wherein the base structure is part of an underbody of a vehicle, or comprises a longitudinal adjusting device with a seat rail and a floor rail, or comprises at least one base member.

3. The foldable vehicle seat as set forth in claim 1, wherein the distance between the hinges of the front support arm differs by about 20% maximum from the distance between the hinge points of the carrier member.

4. The foldable vehicle seat as set forth in claim 1, wherein the front flank and the rear flank are angularly spaced about 50° about 10°.

5. The foldable vehicle seat as set forth in claim 1, wherein in the normal position of utilization of the vehicle seat, the lower hinge point is located in proximity to a connecting line joining the lower hinge of the front support arm and the upper hinge point.

6. The foldable vehicle seat as set forth in claim 1, wherein there is provided a stop device that cooperates with the front flank and the rear flank and that locks the vehicle seat in the normal position of utilization and in the completely folded position.

7. The foldable vehicle seat as set forth in claim 6, wherein the stop device comprises two cams that are motion-linked together, each comprising a stop flank that cooperates with the projection and that there is provided a release lever that is motion-linked to a cam.

8. The foldable vehicle seat as set forth in claim 1, wherein the projection is connected to a connecting rod that is hinge-linked to a rocker arm of the motor, and the rocker arm is connected for rotation with an electric motor.

9. The foldable vehicle seat as set forth in claim 1, wherein in the normal position of utilization of the vehicle seat, a connecting line joining the two hinges of the front support arm is inclined at an angle greater than 45° to a straight line passing through the two hinge points of the carrier member.

10. The foldable vehicle seat as set forth in claim 1, wherein the base structure comprises at least one guide member that comprises a hole for the upper hinge point.

11. The foldable vehicle seat as set forth in claim 1, wherein in the normal position of utilization the front support arm is inclined at an angle of between zero and 30° to the z axis.

12. The foldable vehicle seat as set forth in claim 1, wherein the seat back is pivotally hinged to the upper hinge point.

13. The foldable vehicle seat as set forth in claim 1, wherein in the normal position of utilization the front support arm is inclined at an angle of about 10° to the z axis.

14. The foldable vehicle seat as set forth in claim 5, wherein in the normal position of utilization of the vehicle seat, the lower hinge point is located slightly beneath the connecting line.
